(19) United States
(12) Patent Application Publication
(10) Pub. No.: US 2025/0247490 A1
(43) Pub. Date: Jul. 31, 2025

(54) Reading Device, Reading Method, And Non-Transitory Recording Medium

(71) Applicants: Tatsuya ISHII, Kanagawa (JP); Takehiro CHIBA, Tokyo (JP); Yutaka OHMIYA, Kanagawa (JP); Atsuo TOKUNAGA, Kanagawa (JP); Nobuyoshi KAIMA, Kanagawa (JP)

(72) Inventors: Tatsuya ISHII, Kanagawa (JP); Takehiro CHIBA, Tokyo (JP); Yutaka OHMIYA, Kanagawa (JP); Atsuo TOKUNAGA, Kanagawa (JP); Nobuyoshi KAIMA, Kanagawa (JP)

(73) Assignee: Ricoh Company, Ltd., Tokyo (JP)

(21) Appl. No.: 19/014,987

(22) Filed: Jan. 9, 2025

(30) Foreign Application Priority Data
Jan. 31, 2024 (JP) 2024-013704

(51) Int. Cl. H04N 1/60; H04N 1/028; H04N 1/031; H04N 1/48

(52) U.S. Cl. CPC H04N 1/6027; H04N 1/02865; H04N 1/0313; H04N 1/486; H04N 2201/0081

(57) ABSTRACT

A reading device includes a light source configured to emit a first light band and a second light band towards a reading target object, the first and second light bands being different; an imager including multiple photoelectric conversion elements, each photoelectric conversion element configured to be sensitive to one of multiple light reception wavelengths; and circuitry. The imager receives light having the multiple light reception wavelengths reflected from the reading target object; outputs a first color read value of the reading target object with a first color having a first light reception wavelength of the multiple light reception wavelengths; and outputs a second color read value of the reading target object with a second color having a second light reception wavelength of the multiple light reception wavelengths. The circuitry corrects the first color read value based on the second color read value and output the corrected first color read value.

### CROSS-REFERENCE TO RELATED APPLICATIONS

This patent application is based on and claims priority pursuant to 35 U.S.C. § 119(a) to Japanese Patent Application No. 2024-013704, filed on Jan. 31, 2024, in the Japan Patent Office, the entire disclosure of which is hereby incorporated by reference herein.

### BACKGROUND

### Technical Field

The present disclosure relates to a reading device, a reading method, and a non-transitory recording medium.

### Related Art

A technology for correcting color variations caused by wavelength changes in a light source has been developed for image reading devices that use contact image sensors.

### SUMMARY

The present disclosure described herein provides a reading device including a light source configured to emit a first light band and a second light band towards a reading target object, the first and second light bands being different; an imager including multiple photoelectric conversion elements, each photoelectric conversion element configured to be sensitive to one of multiple light reception wavelengths; and circuitry. The imager receives light having the multiple light reception wavelengths reflected from the reading target object; outputs a first color read value of the reading target object with a first color having a first light reception wavelength of the multiple light reception wavelengths; and outputs a second color read value of the reading target object with a second color having a second light reception wavelength of the multiple light reception wavelengths. The circuitry corrects the first color read value based on the second color read value and output the corrected first color read value.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a hardware configuration of a reading device;

FIG. 2 is a perspective view of a reading device reading an image of a recording sheet;

FIG. 3 is a schematic diagram of a light-emitting diode (LED) array used in a reading apparatus;

FIG. 4 is a schematic diagram of a light receiver used in a reading device;

FIG. 5 is a diagram of a spectral distribution of a white LED;

FIG. 6 is a diagram of a spectral distribution of a white LED before and after its deterioration;

FIG. 7 is a diagram of an output distribution of blue read values when the first color is yellow;

FIG. 8 is a diagram illustrating filter characteristics of a red filter for each wavelength;

FIG. 9 is a table summarizing the readings for each state of the white LED;

FIG. 10 is a block diagram of a functional configuration of correction processing according to a first embodiment;

FIG. 11 is a flowchart of the correction processing in FIG. 10;

FIG. 12 is a diagram illustrating the difference in wavelength distribution caused by the variation in density of the first color;

FIG. 13 is a block diagram of a functional configuration of correction processing according to a second embodiment;

FIG. 14 is a flowchart of the correction processing in FIG. 13;

FIG. 15 is a diagram presenting the relation between the weighted average value used for correction processing and the density;

FIG. 16 is a block diagram of a functional configuration of correction processing according to a third embodiment;

FIG. 17 is a flowchart of the correction processing in FIG. 16;

FIG. 18 is a schematic diagram illustrating a configuration of a printer equipped with a tone correction device;

FIG. 19 is a diagram of stripe patterns for tone correction; and

FIG. 20 is a block diagram of a functional configuration of tone correction processing.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A configuration is known that includes a level correction unit for adjusting the level of an image signal output from multiple photoelectric conversion elements and a color chart characteristic correction unit for correcting the image signal output from the level correction unit when the color chart is imaged by the imaging unit for variations in the characteristic of the color chart.

However, such a known configuration faces challenges in correcting color variations without imaging a color chart.

According to one aspect of the present disclosure, color correction is achieved without imaging a color chart.

Embodiments of a reading device, a reading method, and a recording medium storing a program of the present disclosure are described in detail with reference to the drawings.

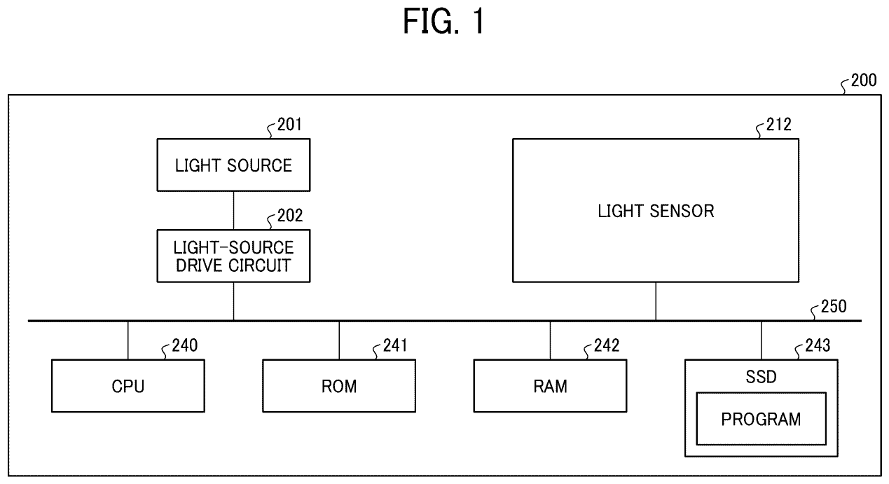

FIG. 1 is a diagram illustrating a hardware configuration of a reading device. The reading device 200 includes a light source 201, a light-source drive circuit 202, a light receiver 212, a central processing unit (CPU) 240, a read only memory (ROM) 241, a random access memory (RAM) 242, and a solid state drive (SSD) 243. The light-source drive circuit 202, the light receiver 212, the CPU 240, the ROM 241, the RAM 242, and the SSD 243 are electrically connected to each other via a system bus 250.

As the light source 201, a light source in which a light-emitting element is placed at an end portion of a light guide body or a light emitting diode (LED) array may be used. The light-source driving circuit 202 controls light emission of the light source 201 based on a control signal output from the CPU 240. The drive signal supplied to the light source 201 may use a rectangular wave, a sine wave, or a voltage waveform having a predetermined waveform shape.

The light receiver 212 is an imager that receives light emitted from the light source 201 and reflected from the reading target object. The light receiver 212 outputs electric signals corresponding to the red, green, and blue wavelength bands, as described in a later configuration.

The CPU 240 loads a program or data from a storage device, such as the ROM 241 or the SSD 243, into the RAM 242 and executes processing to control the entire reading device 200. In one example, part or all of the functions of the CPU 240 may be implemented by an electronic circuit, such as an application specific integrated circuit (ASIC) or a field-programmable gate array (FPGA).

The ROM 241 is a non-volatile semiconductor memory (storage device) that can hold a program or data although the power is turned off. The ROM 241 stores programs or data of, for example, settings of a basic input/output system (BIOS) and an operating system (OS) that are executed when the CPU 240 is activated. The RAM 242 is a volatile semiconductor memory (storage device) that temporarily holds a program or data.

The SSD 243 is a non-volatile memory (a storage device) that stores a program to execute processing by the reading device 200 or various data. The SSD 243 stores, for example, a reading program for reading a document and a correction program for correcting the read document. The CPU 240 executes the correction program to correct the read date, which will be described in detail later. In one example, another storage device such as a hard disk drive (HDD) may be used instead of the SSD 243.

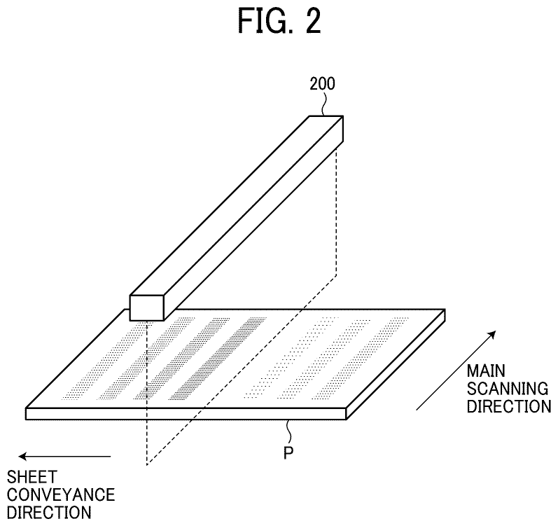

FIG. 2 is a perspective view of how the reading device 200 reads an image on a recording sheet P (e.g., a sheet of paper with printed images or text) as the reading target object. The reading device 200 has a shape elongated in the main scanning direction, and is also called a line sensor. The detection width of the reading device 200 is longer than the width of the recording sheet P in the main scanning direction. Accordingly, when the recording sheet P is conveyed in the conveyance direction so as to pass through the width indicated by the broken line in the main scanning direction, the image density can be detected over the entire area of the recording sheet P.

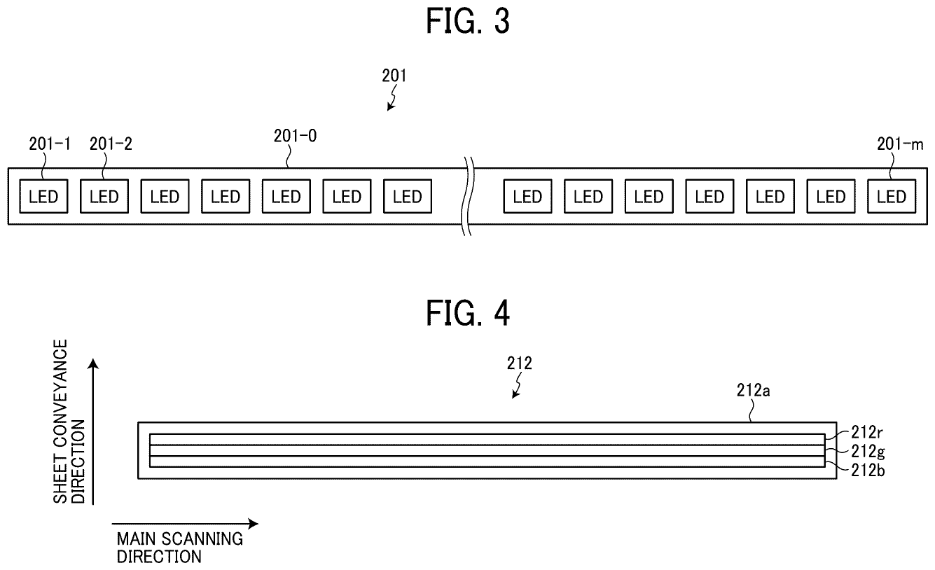

FIG. 3 is a schematic diagram of an LED array used as the light source 201 of the reading device 200. The light sources 201 have a shape extending in the main scanning direction similarly to the reading device 200, and m (m is a positive integer) LED chips (LED 201-1 to 201-m) are arranged on a light-source substrate 201-0. This allows light to be emitted onto the reading target object with a width in the main scanning direction, and the reflected light can be read by the light receiver 212.

As an alternative configuration for the light source 201, a light guide member oriented in the main scanning direction may be used, with two LED chips placed at both ends of the light guide member. These chips can be turned on to emit linear light by directing it through the light guide member. The light guide member can emit light with uniform brightness in the main scanning direction.

In addition, the light source 201 may have a configuration different from the examples described above, as long as the light source 201 can emit linear light in the main scanning direction. For example, a light guide lens may be used to efficiently direct light from the LED array to the region where the edge of the conveyed recording sheet P passes in the main scanning direction.

FIG. 4 is a schematic diagram of a light receiver 212 used in a reading device 200. The light receiver 212 includes a substrate 212a, a pixel array 212r for receiving red light, a pixel array 212g for receiving green light, and a pixel array 212b for receiving blue light.

The pixel array is a component composed of photoelectric conversion elements, such as photodiodes (PDs), which convert optical signals into electrical signals and are arranged in an array along the width direction. Each photoelectric conversion element corresponds to one pixel and outputs an electrical signal according to the amount of received light. The “electrical signal according to the amount of received light” is a typical example of the detection signal. The pixel array outputs electrical signals of pixels for one line.

As illustrated in the drawing, the pixel array 212r, the pixel array 212g, and the pixel array 212b are arranged in the sheet conveyance direction, with the main scanning direction and the pixel arrangement direction being substantially parallel to each other.

The pixel array 212r that receives red light has a red color filter in front of the light receiving surface, and has sensitivity to red wavelengths by receiving red light that has passed through the color filter. The red color filter transmits light in a red wavelength band while absorbing or reflecting light in other wavelength bands. Similarly, the pixel array 212g and the pixel array 212b have green and blue color filters, respectively, and have sensitivity to green and blue wavelengths, respectively, by receiving light in the green and blue wavebands, respectively. The red wavelength band (the light reception wavelength centered on red), the blue wavelength band (the light reception wavelength centered on blue), and the green wavelength band (the light reception wavelength centered on green) are examples of the first light reception wavelength and the second light reception wavelength.

As described above, the light receiver 212 is an imaging unit including multiple photoelectric conversion elements that are sensitive to various predetermined light reception wavelengths, such as red, green, and blue wavelengths. With such a configuration, the light receiver 212 outputs electric signals corresponding to a red read value, a green read value, and a blue read value from the reading target object.

Note that a charge-coupled device (CCD) and a complementary metal oxide-semiconductor (CMOS) may be used for the pixel array. The light receiver 212 may be configured using an area sensor such as a CCD or a CMOS having a two dimensional pixel array. Furthermore, to enhance the light collection efficiency of the light receiver 212, a lens array, such as a rod lens array, may be placed to guide the light reflected from the recording sheet P to the pixel array.

The reading device 200 may be configured by a contact image sensor (CIS). The CIS is an image sensor in which a light receiver, a light source unit, and a rod lens array (or equal magnification imaging system lens) are integrated. By using the CIS, for example, the edge position can be read more compactly by placing the CIS close to the surface of the recording sheet P.

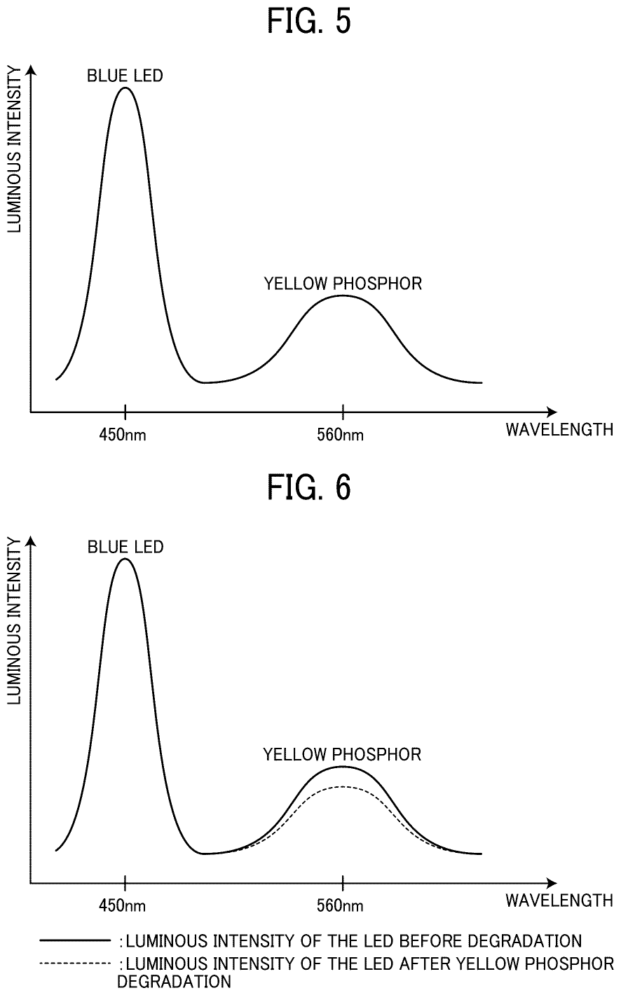

When a white LED with a wide wavelength distribution is used as the LED chip, a common method for reproducing white color involves combining a blue LED with a yellow phosphor to create a pseudo-white effect. FIG. 5 is a diagram of a spectral distribution of a white LED. As described above, the white LED emits light centered at a first emission wavelength (or a first light band) of the blue LEDs (450 nm in FIG. 5) and light centered at a second emission wavelength (or a second light band) of the yellow fluorescent substance (560 nm in FIG. 5).

The degree of temperature change for each LED chip is not uniform and varies. Additionally, the LED chip deteriorates with a large temperature rise. As a result, the LED chip with a large temperature change deteriorates significantly from its initial state. Furthermore, when multiple LED chips are arranged on a substrate as illustrated in FIG. 3, the LED chips, except for those at both ends, are affected by heat from adjacent chips on both sides. In contrast, the chips at both ends are influenced by heat from only one adjacent chip, making the overall heat influence greater for chips not at the ends. When the two LED chips positioned at both ends of the light guide member are used as the light source 201, only these two LED chips are affected by variations in temperature change.

FIG. 6 is a diagram of the spectral distributions of a white LED before and after the yellow phosphor has deteriorated due to long-term use. In FIG. 6, the emission intensity of the yellow phosphor, which has a peak near 560 nm, deteriorates (decreases) from the distribution indicated by the solid line to the distribution indicated by the broken line.

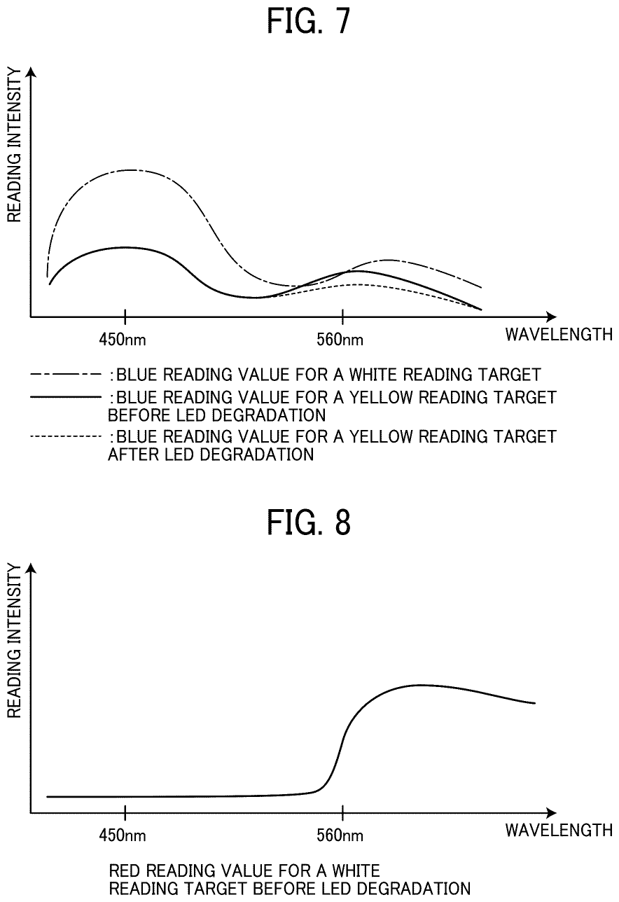

When the emission intensity of the yellow phosphor in the white LED deteriorates in this manner, the output (blue read value) in the blue wavelength band changes relative to the reading target object with a specific color (first color). FIG. 7 is a diagram of an output distribution of blue read values when the first color is yellow. In this figure, the dot-and-dash line represents the blue read value for light reflected from a white reading target object illuminated by a white LED before deterioration and also represents the filter characteristic of the blue filter for each wavelength. The solid line and the broken line represent blue read values for light reflected from a yellow reading target object. The solid line in FIG. 7 represents the blue read value relative to the emission intensity before the yellow phosphor deteriorates (as indicated by the solid line in FIG. 6), while the broken line in FIG. 7 represents the blue read value relative to the emission intensity after the yellow phosphor has deteriorated (as indicated by the broken line in FIG. 6).

Since the blue filter's characteristic also has a peak near 560 nm, when the yellow light reflected from the reading target object is read through the blue filter, the reading intensity is reduced due to the deterioration of the yellow phosphor. In the present embodiment, to correct this, the output (red read value) in the red wavelength band is used when the reading target object is the second color (white).

FIG. 8 represents the red read value for light reflected from a white reading target object illuminated by a white LED before deterioration. In the output of the red wavelength band, the red filter is applied to the reflected light, and FIG. 8 represents the filter characteristics of the red filter for each wavelength. As described above, since the red filter has the characteristic of transmitting the wavelength region near 560 nm of the yellow phosphor, the red read value is reduced due to the deterioration of the yellow phosphor.

When the blue read value for the first color (yellow) is denoted as Yb, the red read value for the second color (white) is denoted as Wr, and the corrected value of Yb is denoted as Yb′, Yb′ is calculated using the following Formula.

Yb′=α×(Yb/Wr) (1)

In this case, α is a predetermined coefficient used to adjust the degree to which Wr influences the corrected value Yb′. The value of a can be determined through evaluation experiments during the design of the reading apparatus or through testing for each reading device during the manufacturing process.

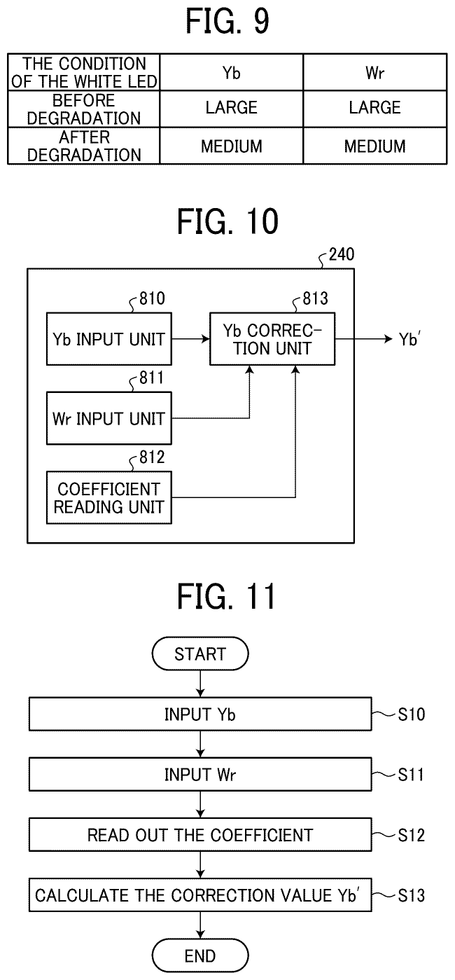

FIG. 9 is a table representing the read values (Yb, Wr) for each color in the different states (before and after deterioration) of the white LED. As described above, the value of Yb is large before the white LED deteriorates and decreases moderately after the LED deteriorates. Similarly, Wr also decreases moderately after the LED deterioration. Thus, the effect of deterioration is neutralized in the corrected value Yb′ by applying the division in Formula (1).

Although division by Wr is used for the correction in the above Formula (1), the following subtraction by Wr may be used as an alternative to division.

Yb′=Yb−β×Wr (2)

In this case, R is a predetermined coefficient used to adjust the degree to which Wr influences the corrected value Yb′. The value of R can be determined through evaluation experiments during the design of the reading apparatus or through testing for each reading device during the manufacturing process.

FIG. 10 is a block diagram of correction processing. The correction processing in CPU 240 includes a Yb input unit 810, a Wr input unit 811, a coefficient reading unit 812, and a Yb correction unit 813.

The Yb input unit 810 inputs a blue read value Yb when the read target object is the first color (yellow). The Wr input unit 811 inputs a red read value Wr when the read target object is the second color (white). The coefficient reading unit 812 reads the coefficient α from Formula (1) or the coefficient R from Formula (2) stored in the storage device, such as the ROM 241, the RAM 242, the SSD 243.

The Yb correction unit 813 corrects Yb by Formula (1) or Formula (2) using Wr and the coefficient, and outputs a correction value Yb′.

FIG. 11 is a flowchart of correction processing. First, CPU 240 inputs the blue read value Yb (step S10), inputs the red read value Wr (step S11), and reads the coefficient α for formula (1) or coefficient R for formula (2) stored in the storage device (step S12). The order of inputting and reading the data is not limited to the order described in the flowchart. For example, Wb may be input, and Yb may be input after the coefficients are read.

CPU 240 corrects Yb by Formula (1) or Formula (2) using Wr and the coefficient, and calculates the corrected value Yb′ (step S13).

As described above, in the present embodiment, the read value of yellow as the first color can be corrected using white as the second color. This allows the influence of LED deterioration to be corrected without the time and effort for reading a special color chart. As the white reading target object, a white plate which is regularly used for correction of a scanner may be used. Further, a margin of the printed recording sheet P may be used.

### Second Embodiment

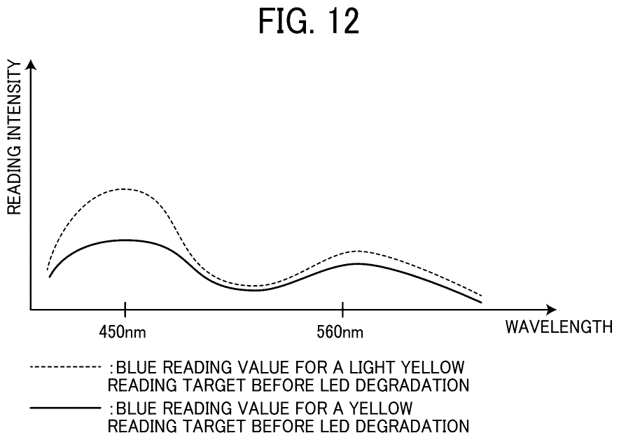

FIG. 12 is a diagram illustrating the difference in wavelength distribution caused by the variation in density of the first color. In FIG. 12, the solid line represents the blue read value (Yb mentioned above) when the first color is yellow, while the broken line represents the blue read value when the first color is light yellow. When the yellow of the first color is moderately dark, the output level of the reflected light from the blue LED is lower than when the yellow is light. Consequently, the influence of the light reflected from the yellow phosphor side is relatively more significant on the blue read value. Thus, as described in the first embodiment, correction is performed using the red read value Wr, which can reflect the influence of deterioration on the yellow phosphor. In contrast, when the first color (yellow) is light, the influence of the reflected light from the blue LED is significant. Thus, it is preferable to perform correction by also considering the blue read value Wb when the reading target is the second color (white).

In the present embodiment, Yb is corrected using only Wr for a dark yellow reading target object, Yb is corrected using an average value of Wr and Wb for a medium density yellow reading target object, and Yb is corrected using only Wb for a light yellow reading target object. Note that correction may be performed using both Wr and Wb for dark yellow, and similarly, correction may be performed using both Wr and Wb for light yellow. In the case of medium-density yellow, the reflection ratio of either Wr or Wb may be increased instead of using the average value of Wr and Wb. However, the ratio of Wr is increased when the density is high, whereas the ratio of Wb is increased when the density is low.

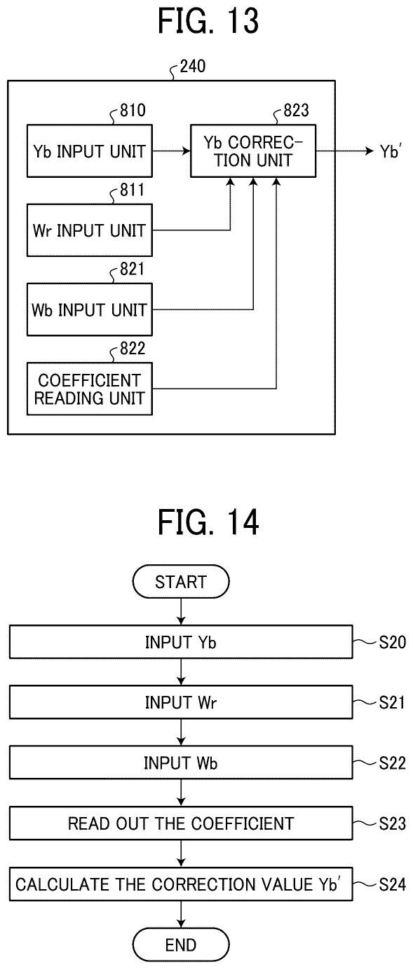

FIG. 13 is a block diagram of a functional configuration of the correction processing according to the second embodiment. The correction processing in CPU 240 includes a Yb input unit 810, a Wr input unit 811, a Wb input unit 821, a coefficient reading unit 822, and a Yb correction unit 823. The operations of the Yb input unit 810 and the Wr input unit 811 are the same as those described in the first embodiment.

The Wb input unit 821 inputs a blue read value Wb when the read target object is the second color (white). The coefficient reading unit 822 reads a coefficient used for correction calculation described below. The Yb correction unit 823 corrects Yb by correction calculation described later using Wr, Wb, and the coefficient, and outputs a correction value Yb′.

The corrected value Yb′ is calculated by the following Formula (3A) to (3C) or Formula (4A) to (4C).

Yb′=γ×(Yb/Wr) (3A)

Yb′=γ×(Yb/(Wr+Wb)/2) (3B)

Yb′=γ×(Yb/Wb) (3C)

Yb′=Yb−δ×Wr (4A)

Yb′=Yb−δ×(Wr+Wb)/2 (4B)

Yb′=Yb−δ×Wb (4C)

In this case, Formula (3A) or (4A) is used for correction when the first color yellow has a high density, formula (3B) or (4B) is used when the first color yellow has a medium density, and Formula (3C) or (4C) is used when the first color yellow has a low density. Furthermore, γ and δ are predetermined coefficients used to adjust the degree of reflection of Wr, (Wr+Wb)/2, or Wb on the corrected value Yb′ These coefficients can be determined through evaluation experiments during the design of the reading device or through tests for each reading device during the manufacturing process.

FIG. 14 is a flowchart of correction processing. First, CPU240 inputs the blue read value Yb (step S20), inputs the red read value Wr (step S21), inputs the red read value Wb (step S22), and reads the coefficient γ of Formula (3A) to (3C) or the coefficient δ of Formula (4A) to (4C) stored in the storage device (step S23). The order of inputting and reading the data is not limited to the order described in the flowchart. For example, Wr and Wb may be input, and Yb may be input after the coefficients are read.

CPU 240 corrects Yb by Formula (3A) to (3C) or Formula (4A) to (4C) using Wr, Wb and the coefficients, and calculates a corrected value Yb′ (step S24).

As described above, in the present embodiment, the influence of the light reflected from the yellow phosphor in the white LED and the light reflected from the blue LED can be appropriately adjusted by correcting the yellow color as the first color based on the density of the yellow reading target object.

### Third Embodiment

In the second embodiment, when the density of the yellow reading target object is categorized into three stages, the correction is performed using a specific correction formula for each density. However, CPU 240 can determine the density d of the reading target object and apply the correction using the following formula (3D) or (4D).

Yb′=γ×(Yb/(d×Wr+(D−d)×Wb)/D) (3D)

Yb′=Yb−δ×((d×Wr+(D−d)×Wb)/D) (4D)

In this case, Formula (3D) corrects Yb by division, and Formula (4D) corrects Yb by subtraction. Further, the density d can theoretically take a range of 0 to D (D>0). When d=D, Formula (3D) is equal to Formula (3A), and Formula (4D) is equal to Formula (4A). When d=D/2, Formula (3D) is equal to Formula (3B), and Formula (4D) is equal to Formula (4B). When d=0, Formula (3D) is equal to Formula (3C), and Formula (4D) is equal to Formula (4C).

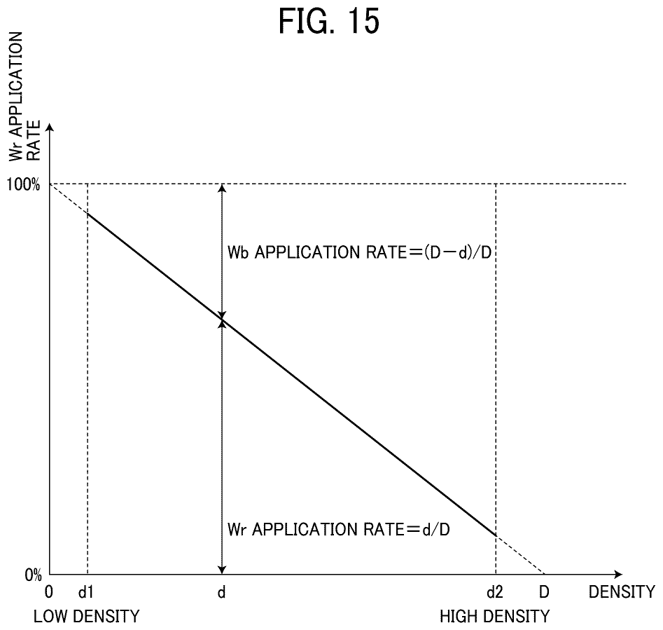

The actual density d is determined in a range of d1 (d1>0) to d2 (d2<D). FIG. 15 is a diagram showing the relationship between the density d and the weighted mean value (d×Wr+(D−d)×Wb)/D of Wr and Wb used for division or subtraction in the Formulae (3D) and (4D). FIG. 15 represents that when the density of the reading target object is d, the application rate of Wr in the correction calculation is d/D, and the application rate of Wb is (D−d)/D.

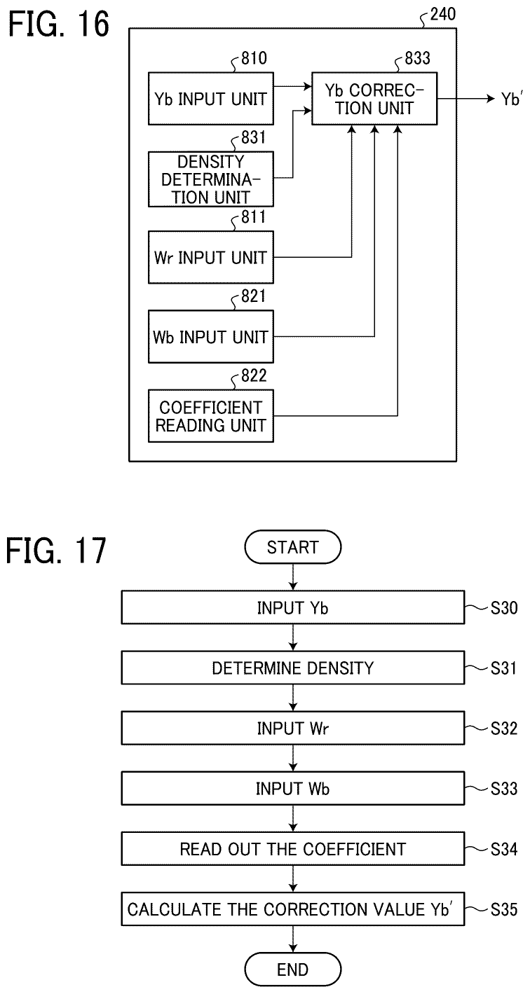

FIG. 16 is a block diagram of a functional configuration of the correction processing. The correction processing in CPU 240 includes a Yb input unit 810, a density determining unit 831, a Wr input unit 811, a Wb input unit 821, a coefficient reading unit 822, and a Yb correction unit 833. The operations of the Yb input unit 810 and the Wr input unit 811 are the same as those in the first embodiment, and the operations of the Wb input unit 821 and the coefficient reading unit 822 are the same as those in the first embodiment. This is the same as the second embodiment.

The density determination unit 831 determines the density d of the first color (yellow) to be read. When the object is a printed matter such as a stripe pattern used in a fourth embodiment described later, the density can be determined using information described in the layout of the printed matter. Additionally, when reading printed matter with a stripe pattern during the adjustment process of the reading apparatus manufacturing, the density of each stripe can be set in advance. In this case, the density determination unit 831 can determine the density based on which band is being read.

The density determination may be performed by estimating the density d using the blue color read value. For example, if the correlation between the density of the reading target object and the blue read value is obtained by, for example, an evaluation experiment in the design stage, the density d can be estimated from the blue read value.

Additionally, the method for determining density may be modified by checking the variations due to degradation of the reading device and the variations in printing of stripe patterns or similar printed matter. For example, when the variation in reading is significant, the density can be determined using the layout information of the printed matter or information about which strip is being read. When the variation in printing is significant, the density may be determined based on the blue read value.

FIG. 17 is a flowchart of correction processing. First, CPU 240 inputs the blue read value Yb (step S30), determines the density d of the read target (step S31), inputs the red read value Wr (step S32), inputs the blue read value Wb (step S33), and reads the coefficient γ for formula (3D) or coefficient δ for formula (4D) stored in the storage device (step S34). The order of inputting and reading the data is not limited to the order described in the flowchart. For example, Wr and Wb may be input, and after the coefficients are read, the input of Yb and the determination of the density may be performed.

Next, CPU 240 corrects Yb by Formula (3D) or (4D) using d, Wr, Wb, and the coefficient, and calculates the corrected value Yb′ (step S35).

As described above, according to the present embodiment, the density of the reading target object is determined, and the read value of yellow which is the first color can be appropriately corrected using the density. Furthermore, since the correction processing can be performed using Formula where the density is a variable, the correction processing can be easily applied even when the number of density levels exceeds three.

### Fourth Embodiment

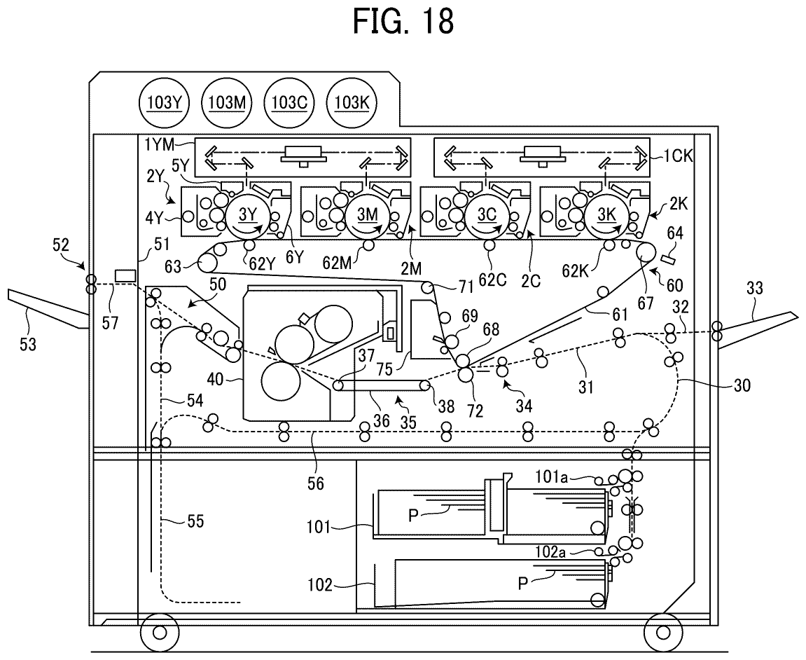

FIG. 18 is a schematic diagram illustrating a configuration of a printer equipped with a tone correction device; In the fourth example, the reading device 200 according to the first to third embodiments is applied to a tone correction apparatus mounted on the printer.

The printer 1000 includes four process units 2Y, 2M, 2C, and 2K to form toner images of yellow (Y), magenta (M), cyan (C), and black (K).

The printer 1000 further includes a sheet feed passage 30, a pre-transfer sheet conveyance passage 31, a bypass sheet feed passage 32, a bypass tray 33, a pair of registration rollers 34, and a sheet conveyance belt unit 35. The printer 1000 further includes a fixing device 40, a conveyance direction switching device 50, a pair of ejection rollers 52, a sheet ejection tray 53, a first sheet feeding tray 101, a second sheet feeding tray 102, and a re-entry device. The printer 1000 also includes two optical writing units 1YM and 1CK. The process units 2Y, 2M, 2C, and 2K include drum-shaped photoconductors 3Y, 3M, 3C, and 3K, which serves as latent image carriers, respectively.

Each of the first sheet feeding tray 101 and the second sheet feeding tray 102 contains a bundle of recording sheets P that serves as recording media. The bundle of recording sheets P includes a recording sheet P that serves as a recording medium. The first sheet feeding tray 101 includes a sheet feed roller 101a, and the second sheet feeding tray 102 includes a sheet feed roller 102a. An uppermost recording sheet P that is placed on top of the bundle of recording sheets P is fed by rotation of a selected one of the sheet feed rollers 101a and 102a toward the sheet feed passage 30. The sheet feed passage 30 leads to the pre-transfer sheet conveyance passage 31 that extends to a secondary transfer nip region. The recording sheet P passes through the pre-transfer sheet conveyance passage 31 immediate before the secondary transfer nip region. After being fed from a selected one of the first sheet feeding tray 101 and the second sheet feeding tray 102, the recording sheet P passes through the sheet feed passage 30 and enters the pre-transfer sheet conveyance passage 31.

In addition, the printer 1000 further includes a housing in which parts and components for image formation are contained. The bypass tray 33 is disposed openably and closably on a side of the housing of the printer 1000 in FIG. 1. The bundle of recording sheets P is loaded on a top face of the bypass tray 33 when the bypass tray 33 is open with respect to the housing. The uppermost recording sheet P placed on top of the bundle of recording sheets P is fed toward the pre-transfer sheet conveyance passage 31 by the sheet feed roller of the bypass tray 33.

Each of the optical writing units 1YM and 1CK, which exposes the surface of the photoconductor to form an electrostatic latent image on the surface of the photoconductor, includes a laser diode, a polygon mirror, and various lenses. Each of the optical writing devices 1YM and 1CK drives the laser diode based on image data of an image that is transmitted from a personal computer. The optical writing units 1YM and 1CK drive laser diodes as light sources based on image signals read by a scanner outside the printer or image signals sent from a personal computer. Then, the photoconductors 3Y, 3M, 3C, and 3K of the process units 2Y, 2M, 2C, and 2K are optically scanned. Specifically, the photoconductors 3Y, 3M, 3C, and 3K of the process units 2Y, 2M, 2C, and 2K are rotationally driven in the counterclockwise direction in FIG. 1. The optical writing device 1YM emits laser light beams to the photoconductors 3Y and 3M while the photoconductors 3Y and 3M are driving, by deflecting the laser light beams in an axial direction of rotation of the photoconductors 3Y and 3M. As a result, the surfaces of the photoconductors 3Y and 3M are optically scanned and irradiated. Thus, the electrostatic latent image based on the yellow and magenta image data are formed on the photoconductor 3Y and 3M. The optical writing device 1CM emits laser light beams to the photoconductors 3C and 3K while the photoconductors 3Y and 3M are driving, by deflecting the laser light beams in an axial direction of rotation of the photoconductors 3C and 3K. As a result, the surfaces of the photoconductors 3C and 3K are optically scanned and irradiated. Thus, the electrostatic latent image based on the cyan and black image data are formed on the photoconductor 3C and 3K.

Each of the process units 2Y, 2M, 2C, and 2K includes, as a single unit, a corresponding one of the photoconductors 3Y, 3M, 3C, and 3K as laten image carriers and components disposed around the corresponding one. The process units 2Y, 2M, 2C, and 2K are detachably attached to the housing of the printer 1000. The photoconductors 3Y, 3M, 3C, and 3K for forming yellow, magenta, cyan, and black toner images have substantially identical configurations to each other, except that the colors of toners to be used for forming respective color toner images are different from each other. The process unit 2 (i.e., the process units 2Y, 2M, 2C, and 2K) includes the photoconductor 3 (i.e., the photoconductor 3Y, 3M, 3C, and 3K) and a developing device 4 (i.e., developing devices 4Y, 4M, 4C, and 4K) that develops an electrostatic latent image formed on a surface of the photoconductor 3 into a visible toner image. The process unit 2 (i.e., the process units 2Y, 2M, 2C, and 2K) further includes a charging device 5 (i.e., charging devices 5Y, 5M, 5C, and 5K) and a drum cleaning device 6 (i.e., drum cleaning devices 6Y, 6M, 6C, and 6K). The charging device 5 uniformly charges the surface of the photoconductor 3 (i.e., the photoconductors 3Y, 3M, 3C, and 3K) while the photoconductor 3 is rotating. The drum cleaning device 6 removes transfer residual toner remaining on the surface of the photoconductor 3 after passing a primary transfer nip region and cleans the surface of the photoconductor 3.

The printer 1000 illustrated in FIG. 1 is a tandem image forming apparatus in which the four process units 2Y, 2M, 2C, and 2K are aligned along a direction of movement of an intermediate transfer belt 61 that functions as a driven target body having an endless loop.

The photoconductor 3 (i.e., the photoconductors 3Y, 3M, 3C, and 3K) is manufactured by a hollow tube made of aluminum, for example, with the front face covered by an organic photoconductive layer having photosensitivity. Each of the photoconductors 3Y, 3M, 3C, and 3K may include an endless belt.

The developing device 4 (i.e., developing devices 4Y, 4M, 4C, and 4K) develops an electrostatic latent image by a two-component developer including magnetic carrier particles and non-magnetic toner. In the following description, the two-component developer is simply referred to as a “developer”. A toner supplier replenishes corresponding color toner to a toner bottle 103 (i.e., toner bottles 103Y, 103M, 103C, and 103K). A toner density detector is disposed in the developing device 4 (i.e., developing devices 4Y, 4M, 4C, and 4K). The toner density detector detects magnetic permeability caused by the carrier which is a magnetic material, and calculates the density of the toner from the amount of the carrier contained in a certain volume. The toner density in the developing device is detected by the toner density detector, and the toner density in the developing device is controlled to be within a certain range (for example, 5 wt % to 9 wt %).

In the present embodiment, the drum cleaning device 6 (i.e., the drum cleaning devices 6Y, 6M, 6C, and 6K) employs a method of pressing a cleaning blade 16 made of a polyurethane rubber pressed against the photoconductor 4. However, in some embodiments, any other suitable cleaning method may be used. In order to enhance the cleaning performance, the printer 1000 employs a rotatable fur brush to contact the photoconductor 3. This fur brush scrapes a solid lubricant into powder and applies the lubricant powder to the surface of the photoconductor 3.

An electric discharging lamp is disposed above the photoconductor 3. The electric discharging lamp is also included in the process unit 2. Further, the electric discharging lamp optically emits light to the photoconductor 3 to remove electricity from the surface of the photoconductor 3 after passing through the drum cleaning device 6. The electrically discharged surface of the photoconductor 3 is uniformly charged by the charging device 5. Then, the above-described optical writing device 1YM starts optical scanning. It is to be noted that the charging device 5 rotates while receiving the charging bias from a power source. Instead of this configuration, the charging device 5 can employ a scorotron charging system in which a charging operation is performed without contacting the photoconductor 3.

Although the process unit 2Y for Y has been described, the process units 2M, 2C, and 2K for M, C, and K have the same configuration as that for 2Y, and thus a detailed description thereof will be omitted.

The transfer unit 60 is disposed below the process units 2Y, 2M, 2C, and 2K. The transfer unit 60 causes the intermediate transfer belt 61 that is an endless belt wound around multiple support rollers (including rollers 63, 67, 68, 69, and 71) with tension to contact the photoconductors 3Y, 3M, 3C, and 3K. While causing the intermediate transfer belt 61 to be in contact with the photoconductors 3Y, 3M, 3C, and 3K, the intermediate transfer belt 61 is rotated by rotation of one of the multiple support rollers so that the intermediate transfer belt 61 endlessly moves in a clockwise direction. Thus, primary transfer nips for Y, M, C, and K are formed where the photoconductors 3Y, 3M, 3C, and 3K and the intermediate transfer belt 61 are in contact with each other.

In proximity to each of the primary transfer nip regions for black, yellow, magenta, and cyan images, the primary transfer rollers 62 (i.e., the primary transfer rollers 62K, 62Y, 62M, and 62C) are disposed in contact with the inner loop of the intermediate transfer belt 61 to press the intermediate transfer belt 25 against the photoconductors 4 (i.e., the photoconductors 4K, 4Y, 4M, and 4C), respectively. A primary transfer bias is applied by respective transfer bias power supplies to the primary transfer rollers 62Y, 62M, 62C, and 62K. Consequently, respective primary transfer electric fields are generated in the primary transfer nip regions to electrostatically transfer respective toner images formed on the photoconductors 3Y, 3M, 3C, and 3K onto the intermediate transfer belt 61.

The toner images are sequentially superimposed and primarily transferred at the respective primary transfer nips onto the front surface of the intermediate transfer belt 61 that sequentially passes through the primary transfer nips for Y, M, C, and K in accordance with the endless movement in the clockwise direction in the drawing. Due to the primary transfer of the toner images, a four-color composite toner image (referred to as a four-color toner image) is formed on the surface of the intermediate transfer belt 61.

The secondary transfer roller 72 positioned below the intermediate transfer belt 61 in FIG. 1 contacts a secondary transfer backup roller 68 at a position where the secondary transfer roller 72 faces the secondary transfer backup roller 68 via the outer surface of the intermediate transfer belt 61, which forms a secondary transfer nip region. As a result, a secondary transfer nip is formed at which the secondary transfer roller 72 contacts the outer surface of the intermediate transfer belt 61.

A secondary transfer bias is applied by a transfer bias power supply to the secondary transfer roller 72. By contrast, the secondary transfer backup roller 68 disposed inside the belt loop of the intermediate transfer belt 61 is electrically grounded. By so doing, a secondary transfer electric field is formed in the secondary transfer nip region.

The pair of registration rollers 34 is disposed on the right side of the secondary transfer nip region in FIG. 1. The pair of registration rollers 34 holds and conveys the recording sheet P to the secondary transfer nip region in synchronization with arrival of the four-color toner image formed on the intermediate transfer belt 61 so as to further convey the recording medium P toward the secondary transfer nip region. In the secondary transfer nip region, the four-color toner image formed on the intermediate transfer belt 61 is transferred onto the recording sheet P due to the secondary transfer electric field and a nip pressure. At this time, the four-color toner image is combined with white color of the recording sheet P to make a full-color toner image.

A sensor 64, which is a reflective optical sensor that detects the amount of toner adhered, is disposed between the primary transfer nip and the secondary transfer nip. A reflective optical sensor includes a light-emitting element and a light-receiving element. Light emitted from the light-emitting element is directed onto a toner patch on the intermediate transfer belt 61. This light is then reflected back from the toner patch and captured by the light-receiving element, subsequently being converted into a signal. The information of the test pattern is analogized by reading the change in the signal, and the amount of adhesion of the toner patch is detected.

Non-transferred residual toner, which has not transferred onto the recording sheet P at the secondary transfer nip, adheres to the outer surface of the intermediate transfer belt 61 having passed the secondary transfer nip. The transfer residual toner is cleaned by a belt cleaning device 75 that is in contact with the intermediate transfer belt 61.

The recording sheet P that has passed through the secondary transfer nip region separates from the intermediate transfer belt 61 to be conveyed to the conveyance belt unit 35. The sheet conveyance belt unit 35 includes a transfer belt 36, a drive roller 37, and a driven roller 38. The transfer belt 36 having an endless belt is wound around the drive roller 37 and the driven roller 38 with taut and is endlessly rotated in the counterclockwise direction in FIG. 1 along with rotation of the drive roller 37. While nipping the recording sheet P that is conveyed from the secondary transfer nip region on the outer circumferential surface (the stretched surface) of the transfer belt 36, the sheet conveyance belt unit 35 forwards the recording sheet P along with the endless rotation of the transfer belt 36 toward the fixing device 40.

The recording sheet P that has passed through the secondary transfer nip is sent into the fixing device 40 and is nipped in the fixing nip. Then, the toner image is fixed by the action of pressure and heat. The recording sheet P, on the first side of which the toner image has been transferred at the secondary transfer nip and on which the toner image has been fixed by the fixing device 40, is sent out toward the conveyance direction switching device 50.

The printer 1000 further includes a sheet reversing device including the conveyance direction switching device 50, a re-entry passage 54, a switchback passage 55, and a post-switchback passage 56. Specifically, after receiving the recording sheet P from the fixing device 40, the conveyance direction switching device 50 switches a direction of conveyance of the recording sheet P, in other words, a direction in which the recording sheet P is further conveyed, between the sheet ejection passage 57 and the re-entry passage 54. When printing an image on a first face of the recording sheet P and not printing on a second face, a single-side printing mode is selected. When performing a print job in the single-side printing mode, a route of conveyance of the recording sheet P is set to the sheet ejection passage 57. According to the setting, the recording sheet P having the image on the first face is conveyed toward the pair of sheet ejecting rollers 52 via the sheet ejection passage 57 to be ejected to the sheet ejection tray 53 that is attached to an outside of the image forming apparatus 200. When printing images on both first and second faces of a recording sheet P, a duplex printing mode is selected. When performing a print job in the duplex printing mode, after the recording sheet P having fixed images on both first and second faces is conveyed from the fixing device 40, a route of conveyance of the recording sheet P is set to the sheet ejection passage 57. According to the setting, the recording sheet P having images on both first and second faces is conveyed and ejected to the sheet ejection tray 53. By contrast, when performing a print job in the duplex printing mode, after the recording sheet P having a fixed image on the first face is conveyed from the fixing device 40, a route of conveyance of the recording sheet P is set to the re-entry passage 54.

The re-entry passage 54 is connected to the switchback passage 55. The recording sheets P conveyed to the re-entry passage 54 enters the switchback passage 55. Consequently, when the entire region in the sheet conveying direction of the recording sheet P enters the switchback passage 55, the direction of conveyance of the recording sheet P is reversed, so that the recording sheet P is switched back in the reverse direction. The switchback passage 55 is connected to the post-switchback passage 56 as well as the re-entry passage 54. The recording sheet P that has been switched back in the reverse direction enters the post-switchback passage 56. Accordingly, the faces of the recording sheet P is reversed upside down. Consequently, the reversed recording sheet P is conveyed to the secondary transfer nip region again via the post-switchback passage 56 and the sheet feed passage 30. A toner image is transferred onto the second face of the recording sheet P in the secondary transfer nip region. Thereafter, the recording sheet P is conveyed to the fixing device 40 so as to fix the toner image to the second face of the recording sheet P. Then, the recording sheet P passes through the conveyance direction switching device 50 and the pair of sheet ejecting rollers 52 before being ejected on the sheet ejection tray 53. A reading device 200 as a detector for detecting the image density on the recording sheet P is disposed in front of the pair of paper discharge rollers 52, and detects the image density on the recording sheet P in the tone correction operation described later.

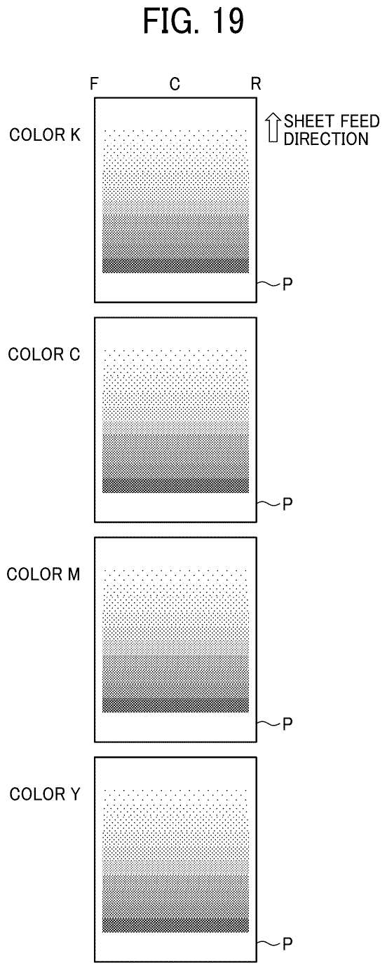

FIG. 19 is a diagram of band-shaped patters for gradation correction. In the present embodiment, a band-shaped pattern of one color is printed on one recording sheet P. In the present embodiment, eleven band-shaped patterns having different gradation levels are formed on one recording sheet P. Multiple band-shaped patterns are formed so that the number of gradations increases by 20 from downstream to upstream in the direction of feed of sheet. In the present embodiment, for one color, band-shaped patterns of 20 gradations, 40 gradations, 60 gradations, 80 gradations, 100 gradations, 120 gradations, 140 gradations, 160 gradations, 180 gradations, 200 gradations, and 220 gradations are printed.

The number of band-shaped patterns on a recording sheet and the number of gradations of each pattern can be set as needed. For example, the number of printed sheets may be reduced by reducing the number of band-shaped patterns or the number of gradations of each band-shaped pattern.

The image density at each position in the main scanning direction of multiple stripe patterns of Y, M, C, and K colors formed on four recording sheets P is detected by the reading device 200, and the density unevenness of each color in multiple main scanning directions is acquired. In the present disclosure, density unevenness refers to density fluctuations in the main scanning direction that occur in an image printed by the printer due to deviations in the main scanning direction caused by variations in mechanical accuracy. In the present embodiment, for each color, a relation is established between eleven tones, i.e., 20, 40, 60, 80, 100, 120, 140, 160, 180, 200, and 220, and the density unevenness in the main scanning direction.

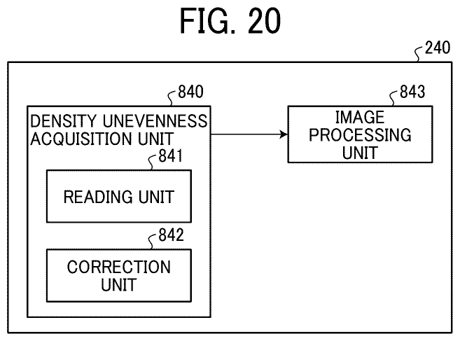

FIG. 20 is a block diagram of gradation correction processing.

The tone correction processing in the tone correction device according to the present embodiment is implemented by the CPU 240 of the reading device 200. The tone correction processing by the CPU 240 includes a density unevenness acquisition unit 840 and an image processing unit 843. The density unevenness acquisition unit 840 includes a reading unit 841 and a correction unit 842.

The density unevenness acquisition unit 840 acquires density unevenness of the image density on the recording sheet P read by the reading device 200. The reading unit 841 reads the red read value and the blue read value of the reading device 200, and the correction unit 842 corrects the data of the blue read value for the Y color stripe pattern using the processing as described above. The density unevenness acquisition unit 840 inputs the data of the density unevenness corrected in this way to the image processing unit 843.

The image processing unit 843 obtains a tone correction amount for each area along the main scanning direction, for all the tones between the stripe patterns, based on the density unevenness data. The image processing unit 843 obtains a gradation correction table from the tone correction amount, and performs tone correction for each area in the main scanning direction based on the tone correction table. The tone correction amount may be any amount that corrects density unevenness prevent density unevenness from occurring and is obtained by a known method. The tone correction table is a table that maps the corrected tone value for each tone value from 1 to 230 in image data and is determined using a known method with the use of tone correction amounts.

As described above, when reading the density unevenness data used for tone correction processing in the printer, corrections can be made to mitigate the effects of white LED deterioration, enabling appropriate tone correction processing. Further, by using the reading device 200 according to the second or third embodiment, the density unevenness data can be corrected based on the density of the stripe pattern used for tone correction, allowing the tone correction processing to be performed more effectively.

Note that the correction application range in the first to fourth embodiments may include the entire reading screen, a main scanning area unit, and an LED chip unit. Since correcting the entire reading screen increases the amount of calculation, it is preferable in practice to perform corrections in main scanning area units, as done in the fourth embodiment. However, if the deterioration state varies between LED chips, the correction may be performed on an LED chip basis.

In addition, the correction of the read value of yellow by the blue filter when the blue LED and the yellow phosphor are used as the light source has been described, but the light source and the light receiver of the present embodiment are not limited thereto. For example, if both the value O11 obtained from reading the first color and the value O22 obtained from reading the second color tend to decrease due to the deterioration of a light source with a specific spectral distribution, the corrected value O11F can be calculated using one of the following Formula (5) or (6).

O11′=α×(O11/O22) (5)

O11′=O11−−×O22 (6)

Thus, in the present embodiment, the light source is not limited to the white LED, the first and second colors are not limited to yellow and white, and the filters applied in the light receiver are not limited to the red and blue filters. Furthermore, when the value O21 obtained from reading the second color can be used for correction based on the density d of the first color, the corrected value O11F can be calculated using either of the following Formula (7) or (8).

O11′=γ×(O11/(d×O22+(D−d)×O21)/D) (7)

O11′=O11−δ×((d×O22+(D−d)×O21)/D) (8)

In this case, the coefficients α, β, γ, and δ are predetermined coefficients, and may be the same as or different from the coefficients in the embodiments.

Aspects of the present disclosure are, for example, as follows.

<1>

A reading device includes a light source configured to emit a first light band and a second light band towards a reading target object, the first and second light bands being different; an imager including multiple photoelectric conversion elements, each photoelectric conversion element configured to be sensitive to one of multiple light reception wavelengths; and circuitry. The imager receives light having the multiple light reception wavelengths reflected from the reading target object; outputs a first color read value of the reading target object with a first color having a first light reception wavelength of the multiple light reception wavelengths; and outputs a second color read value of the reading target object with a second color having a second light reception wavelength of the multiple light reception wavelengths. The circuitry corrects the first color read value based on the second color read value and output the corrected first color read value.

<2>

A reading device includes a light source configured to emit a first light band and a second light band towards a reading target object, the first and second light bands being different; an imager including multiple photoelectric conversion elements, each photoelectric conversion element configured to be sensitive to one of multiple light reception wavelengths; and circuitry. The imager is configured to receive light having the multiple light reception wavelengths reflected from the reading target object; output a first color read value of the reading target object with a first color having a first light reception wavelength of the multiple light reception wavelengths; output a second color read value of the reading target object with a second color having a second light reception wavelength of the multiple light reception wavelengths; output a third color read value of the reading target object with the second color having the first light reception wavelength. The circuitry is configured to correct the first color read value based on the second color read value and the third color read value and output the corrected first color read value.

<3>

In the reading device according to <1> or <2>, the first light band includes a blue wavelength, and the second light band includes a yellow wavelength.

<4>

In the reading device according to any one of <1> to <3>, the first light reception wavelength is a red wavelength, and the second light reception wavelength is a blue wavelength.

<5>

In the reading device according to any one of <1> to <4>, the first color is yellow, and the second color is white.

<6>

In the reading device according to any one of <1> to <5>, the circuitry is further configured to change a ratio of the second color reading value and the second color read value, which are used for correcting the first color read value, according to a density of the first color.

<7>

In the reading device according to any one of <1> to <6>, the circuitry is further configured to: multiply the second color read value by a coefficient to obtain a value; and divide or subtract the first color read value with the value to correct the first color read value.

<8>

In the reading device according to <2> or <3>, wherein the circuitry is further configured to: multiply a weighted average of the second color read value and the third color read value by a coefficient to obtain a value; and divide or subtract the first color read value with the value to correct the first color read value.

<9>

A reading method incudes emitting light from a light source that emits a first light band and a second light band towards a reading target object, the first and second light bands being different; receiving light having multiple light reception wavelengths reflected from the reading target object by an imager including multiple photoelectric conversion elements, each photoelectric conversion element configured to be sensitive to one of the multiple light reception wavelengths; outputting a first color read value of the reading target object with a first color having a first light reception wavelength of the multiple light reception wavelengths; outputting a second color read value of the reading target object with a second color having a second light reception wavelength of the multiple light reception wavelengths; correcting the first color read value based on the second color read value; and outputting the corrected first color read value.

<10>

A non-transitory recording medium storing a plurality of instructions which, when executed by one or more processors, causes the one or more processors to perform a reading method including emitting light from a light source that emits a first light band and a second light band towards a reading target object, the first and second light bands being different; receiving light having multiple light reception wavelengths reflected from the reading target object by an imager including multiple photoelectric conversion elements, each photoelectric conversion element configured to be sensitive to one of the multiple light reception wavelengths; outputting a first color read value of the reading target object with a first color having a first light reception wavelength of the multiple light reception wavelengths; outputting a second color read value of the reading target object with a second color having a second light reception wavelength of the multiple light reception wavelengths; correcting the first color read value based on the second color read value; and outputting the corrected first color read value.

<11>

In the reading device according to <1>, the first color read value includes first color subread values corresponding to different portions of the reading target object. The second color read value includes second color subread values corresponding to different portions of the reading target object. The second color subread values matches the portions of the reading target object of the first color subread values, and corrects the first color subread values based on the respective second color subread values.

<12>

In the reading device of <2>, the first color read value includes first color subread values corresponding to different portions of the reading target object, and the second color read value includes second color subread values corresponding to different portions of the reading target object. The second color subread values matches the portions of the reading target object of the first color subread values. The third color read value includes third color subread values corresponding to different portions of the reading target object. The third color subread values matches the portions of the reading target object of the first color subread values. The circuitry is further configured to change a ratio of the second color subread value and the third color subread value, which are used for correcting the first color subread value, according to a density of the first color in the respective portion of the reading target object.

<13>

In the reading device of <2>, the circuitry is further configured to determine a density unevenness of the reading target object, determine a tone correction based on the density unevenness, and apply the tone correction to the first, second, and third color read values.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A reading device comprising:
a light source configured to emit a first light band and a second light band towards a reading target object, the first and second light bands being different;
an imager including multiple photoelectric conversion elements, each photoelectric conversion element configured to be sensitive to one of multiple light reception wavelengths, the imager configured to:
receive light having the multiple light reception wavelengths reflected from the reading target object; and
output a first color read value of the reading target object with a first color having a first light reception wavelength of the multiple light reception wavelengths; and
output a second color read value of the reading target object with a second color having a second light reception wavelength of the multiple light reception wavelengths; and
circuitry configured to correct the first color read value based on the second color read value and output the corrected first color read value.

2. A reading device comprising:
a light source configured to emit a first light band and a second light band towards a reading target object, the first and second light bands being different;
an imager including multiple photoelectric conversion elements, each photoelectric conversion element configured to be sensitive to one of multiple light reception wavelengths, the imager configured to:
receive light having the multiple light reception wavelengths reflected from the reading target object;
output a first color read value of the reading target object with a first color having a first light reception wavelength of the multiple light reception wavelengths;
output a second color read value of the reading target object with a second color having a second light reception wavelength of the multiple light reception wavelengths;
output a third color read value of the reading target object with the second color having the first light reception wavelength; and
circuitry configured to correct the first color read value based on the second color read value and the third color read value and output the corrected first color read value.

3. The reading device according to claim 1, wherein:
the first light band includes a blue wavelength, and
the second light band includes a yellow wavelength.

4. The reading device according to claim 1, wherein:
the first light reception wavelength is a red wavelength, and
the second light reception wavelength is a blue wavelength.

5. The reading device according to claim 1, wherein:
the first color is yellow, and
the second color is white.

6. The reading device according to claim 2, wherein the circuitry is further configured to change a ratio of the second color read value and the third color read value, which are used for correcting the first color read value, according to a density of the first color.

7. The reading device according to claim 2, wherein the circuitry is further configured to:
multiply the second color read value by a coefficient to obtain a value; and
divide or subtract the first color read value with the value to correct the first color read value.

8. The reading device according to claim 2, wherein the circuitry is further configured to:
multiply a weighted average of the second color read value and the third color read value by a coefficient to obtain a value; and
divide or subtract the first color read value with the value to correct the first color read value.

9. A reading method comprising;
emitting light from a light source that emits a first light band and a second light band towards a reading target object, the first and second light bands being different;
receiving light having multiple light reception wavelengths reflected from the reading target object by an imager including multiple photoelectric conversion elements, each photoelectric conversion element configured to be sensitive to one of the multiple light reception wavelengths;
outputting a first color read value of the reading target object with a first color having a first light reception wavelength of the multiple light reception wavelengths;
outputting a second color read value of the reading target object with a second color having a second light reception wavelength of the multiple light reception wavelengths;
correcting the first color read value based on the second color read value; and
outputting the corrected first color read value.

10. A non-transitory recording medium storing a plurality of instructions which, when executed by one or more processors, causes the one or more processors to perform a reading method comprising;
emitting light from a light source that emits a first light band and a second light band towards a reading target object, the first and second light bands being different;
receiving light having multiple light reception wavelengths reflected from the reading target object by an imager including multiple photoelectric conversion elements, each photoelectric conversion element configured to be sensitive to one of the multiple light reception wavelengths;
outputting a first color read value of the reading target object with a first color having a first light reception wavelength of the multiple light reception wavelengths;
outputting a second color read value of the reading target object with a second color having a second light reception wavelength of the multiple light reception wavelengths;
correcting the first color read value based on the second color read value; and
outputting the corrected first color read value.

11. The reading device according to claim 1, wherein
the first color read value includes first color subread values corresponding to different portions of the reading target object,
the second color read value includes second color subread values corresponding to different portions of the reading target object, the second color subread values matching the portions of the reading target object of the first color subread values, and correcting the first color subread values based on the respective second color subread values.

12. The reading device of claim 2, wherein
the first color read value includes first color subread values corresponding to different portions of the reading target object,
the second color read value includes second color subread values corresponding to different portions of the reading target object, the second color subread values matching the portions of the reading target object of the first color subread values,
the third color read value includes third color subread values corresponding to different portions of the reading target object, the third color subread values matching the portions of the reading target object of the first color subread values, and
the circuitry is further configured to change a ratio of the second color subread value and the third color subread value, which are used for correcting the first color subread value, according to a density of the first color in the respective portion of the reading target object.

13. The reading device of claim 2, wherein the circuitry is further configured to determine a density unevenness of the reading target object, determine a tone correction based on the density unevenness, and apply the tone correction to the first, second, and third color read values.
